(19) United States
(12) Patent Application Publication
(10) Pub. No.: US 2006/0039246 A1
(43) Pub. Date: Feb. 23, 2006

(54) Adaptive system to allow multiple update and correction sessions on an optical data storage card

(75) Inventors: Francis K. King, San Jose, CA (US); Jeffrey F. Liu, San Jose, CA (US)

Correspondence Address: Bo-In Lin, 13445 Mandoli Drive, Los Altos Hills, CA, 94022, US

(73) Assignee: DCARD, INC.

(21) Appl. No.: 10/922,315

(22) Filed: Aug. 19, 2004

(51) Int. Cl. G11B 21/08; G11B 19/02

(52) U.S. Cl. 369/30.01; 369/47.1; 369/53.24

(57) ABSTRACT

An adaptive method of managing system configuration in either a rewritable or a write-once optical card with zones formed in combination with an emulated drive buffer to behave as a Direct-access device. In the card medium, zones are formed for recording user data and the capacity of each zone is variable according to the available volume capacity, partition capacity, and user requirement, a spare area for recording alternative sectors; a defect list area for recording a defect list and a table area for usage and definition of user zones.

### BACKGROUND OF THE INVENTION

1. Field of the Invention

This invention relates generally to systems and method for controlling an optical pickup head for reading data from and writing data to data storage medium. More particularly, this invention is related to an improve method for optical disk tracking servo and focusing servo circuits enabled to compensate for either continuous or non-continuous track segments or prolonged defect data tracks.

2. Description of the Prior Art

The technologies as that commonly implemented in conventional Direct-Access information-recording and reproducing apparatuses, particularly those applied to “write-once” medium, cannot be conveniently applied to the optical data tracks supported on a card-shaped medium for recording data related to personal information such personal photo, biometric data and/or medical records, etc. Specifically, in a write-once optical disk, the recorded information cannot be rewritten; the contents stored in a file-allocation table (FAT) cannot be updated. The described file management technique is not valid and a rewritable optical disk does not have this type of problem. With it inherent very large capacity property, optical disk such as CDR, CDRW, DVDR, or DVDRW can use a multiple session method. This multiple session method allows a write-once optical disk to update information by creating a new session area and discarding the earlier sessions. Each session area has its own lead-in, data, and lead-out areas. The lead-in area has table of contents information and lead-out area indicates the end of data and end of this particular session information. The data area can use either 1988 ISO 9660 or OSTA Universal Data Format file management method. Comparatively, an optical write-once data card does not have the tremendous capacity provided by CDR, CDRW, DVDR, or DVDRW. The capacity of an optical card is not even enough to contain a convention CDR or CDRW lead-in area. A write once data card is therefore limited with options to update or correct data written on the cards. Even a rewritable data card capacity may not be enough for the conventional lead-in and lead out format requirement. Such limitations may unduly increases the operation costs and causes great deal of difficulties if a requirement for data update or error correction arises.

The file structure in a recording medium contains significant information related to the file structure and status of these files to allow a data access device to efficiently access the data stored in different data tracks. Specifically, Direct-Access information-recording and reproducing apparatus such as a magnetic disk and floppy disk, the file management including the defective sector management, a directory area for recording management information and a data area for recording file data are formed on the disk. A file allocation table (FAT) area is also formed in the disk to record an FAT for controlling the status of the data area. In such a disk, a defective may occur due to flaws, contamination or deterioration of the recording material, an identification flag is recorded in the FAT entry corresponding to such a defect. When a disk is formatted to initialize FAT entries, an unused flag meaning that unused areas are recorded in FAT entries in addition to the defect area entries. When recording a new file, FAT entries are updated to reflect the new usage of the area. In this operation, FAT entries having the defect flag are skipped so that defective area will not be used in recording the new file. After the data of the new file are recorded in unused area, the FAT is updated by rewriting the information, which describes the new status.

For optical disk configurations, U.S. Pat. No. 4,611,314 Ogata et al. Sep. 9, 1986 discussed a defect and data buffer management method of an optical disk, U.S. Pat. No. 4,682,318 Busby Jul. 21, 1987 discusses a multiple-zone methods with a temporary location for intermediate data, U.S. Pat. No. 4,677,606 Ogata et al. Jun. 30, 1987 discussed a multiple zones and blocks with pre-determined address assignment. U.S. Pat. No. 5,111,444 Fukushima et al. May 5, 1992 discussed a defect management of multiple zones. In U.S. Pat. No. 4,775,969, issued on Oct. 4, 1988, Osterlund discussed the emulation of a tape device with optical disk. These methods are not suitable for an optical write-once data card.

These patented inventions however do not provide relevant or an effective solution to enable a card-sized optical recording medium formed with write-once and rewritable data storage data tracks to carry out data update or error corrections on the recording medium. Therefore, a need still exists in the art to provide improved and new configuration and data access process to overcome such limitations.

### SUMMARY OF THE PRESENT INVENTION

Therefore, an object of this invention is to provide a method and a system configuration to enable multiple sessions of data update operation in a non-rewritable information-recording medium supported on a card, e.g., a credit card or ID card and for a limited capacity rewritable data card that can not have conventional lead-in and lead-out type format. It is a further object to provide a method and system configuration to manage defective sectors in a non-rewritable information-recording medium, particularly for such medium supported on a card. Since the data tracks are formed as arc segments, it is further an object to provide a method for managing entries of starting sector and ending sector of a track in non-continuous track segment arrangement in a card-shaped information-recording medium. It is a further object to provide a method for detecting of starting sector of a track in non-continuous track segment arrangement in a card-shaped information-recording medium. In order to more conveniently carry out multiple sessions of data update operation, it is further an object to provide a method for managing a card-shaped information-recording medium as a direct-access device by implementing emulated buffer on a data access device and on a host computer. It is a further object of this invention to provide a data access device to format and process a plurality of optical data arcs ready for storing data and for a pickup head to access and update the data and to handle the defective data tracks with data stored in the formatted tracks.

Briefly, in a preferred embodiment, the present invention discloses a data access device for accessing data stored in a card-shaped medium supporting a plurality of recording arc segments thereon. The data access device further includes a plurality of data tracks disposed on the non-rewritable card-shaped information-recording medium including a first segment of the data tracks storing an address pointing to a multiple session management location in said data tracks employed for carrying out multiple sessions of data updates on the non-rewritable or rewritable card-shaped recording medium. In a preferred embodiment, the non-rewritable card-shaped information-recording medium further includes a second segment of the data tracks for storing an address pointing to a defect management location in the data tracks for storing data employed for managing a defect in the data tracks. The format of a session applies to not only to a non-rewritable card shaped medium but also to a rewritable card shaped medium.

In a preferred embodiment, this invention further discloses a method for enabling multiple sessions of data updates in a non-rewritable and rewritable card-shaped information-recording medium. The method includes a step of providing a plurality of data tracks on the non-rewritable or rewritable card-shaped information-recording medium and allocating a segment of the data tracks for providing an address pointing to a multiple session management location in the data tracks employed for carrying out the multiple sessions of data updates. The method further includes a step of allocating a segment of the data tracks for providing an address pointing to a defect management location in the data tracks for storing data employed for managing a defect in the data tracks.

These and other objects and advantages of the present invention will no doubt become obvious to those of ordinary skill in the art after having read the following detailed description of the preferred embodiment, which is illustrated in the various drawing figures.

### BRIEF DESCRIPTION OF THE DRAWINGS

FIG. 1A shows a non-rewritable and rewritable card-shaped information-recording medium with non-continuous track segment arrangement at an optical memory area and possible smart chip and magnetic stripe.

FIG. 1B shows a non-rewritable and rewritable card-shaped information-recording medium with circular continuous track arrangement at an optical memory area and a possible smart chip.

FIG. 1C shows a non-rewritable and rewritable card-shaped information-recording medium with circular continuous track arrangement at an optical memory area with possible smart chip and magnetic stripe.

FIG. 2 shows the format of a logical optical track that can map to physical optical tracks.

FIG. 3 shows separate areas allocated for different purpose in the segmented optical area.

FIG. 4A shows a starting sector map area and entries of sector address.

FIG. 4B shows a physical arrangement of tracks with starting sectors at each track aligned to each other.

FIG. 4C shows a physical arrangement of tracks with starting sectors at each track not aligned to each other.

FIG. 5 shows a multiple session control table.

FIG. 6 shows the mapping arrangement of the emulated direct-access buffer.

FIG. 7 shows a defect entry table.

FIG. 8 shows mapping method between host and the data access device that recognizes logical address and the physical address on the card.

FIG. 9 shows a non-rewritable card and an emulated direct-access buffer built in with optical card reader/writer interface with a host system.

FIG. 10 shows a non-rewritable card interfaces with a host system with an emulated direct-access buffer.

FIG. 11 shows an emulated direct-access device buffer arrangement.

FIG. 12 shows method to detect a starting sector of a segmented track.

FIG. 13 shows the conversion of logical address to physical address.

FIG. 14 shows method to update card information through the emulated FIG. 15 shows method to generate defect map table.

FIG. 16 shows method to use defect map sectors.

### DETAILED DESCRIPTION OF THE PREFERRED EMBODIMENT

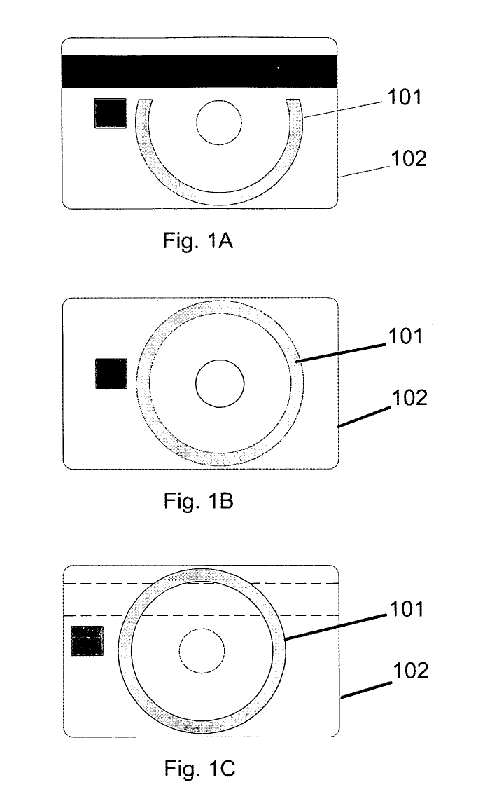

Referring to FIGS. 1A, 1B, and 1C for a data card 102, e.g., a credit card, that supports an optical non-rewritable data storage area 101. The data storage area 102 includes a plurality of optical data tracks and these data tracks are formed as circular arc segments or full circular tracks. Since these arc segments in FIG. 1A have a track starting point and a track ending point, unlike the data tracks disposed on a regular flat medium such as a compact disk (CD) or a floppy disk, these arc segments are not continuous from one track to the next. For this reason, the data access processes in reading or writing data to and from these data tracks must have special servo control to determine the beginning and the end of each arc segment employed for data storage. FIG. 1B or 1C arranged with full circular concentric or spiral tracks does not need the special method to detect the beginning or ending points of track arc segments. Furthermore, these arc segments or circular tracks are implemented as non-rewritable data storage medium for storing personal information, e.g., medical records, biometric data, personal photos, etc. Since these data arcs or circle are formed as “write-once” medium, this invention discloses system configuration and data processing methods to perform multiple-session data updates or information corrections operations on these data arcs or circles as optical data tracks supported on the card-sized medium.

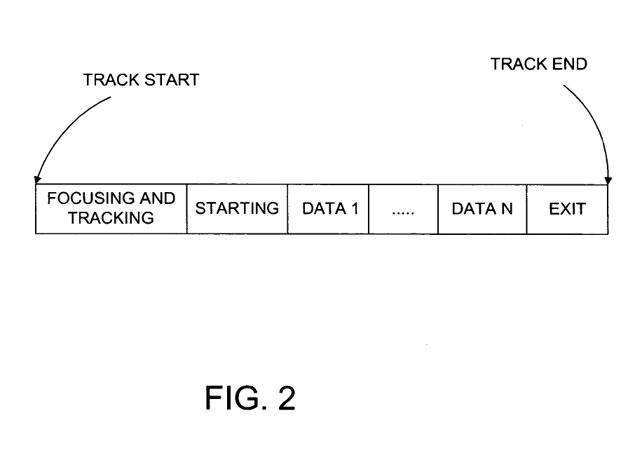

In order to achieve these purposes, the present invention discloses special method to configure the optical data tracks formed as a plurality of arc segments or circular tracks with special formats. All data tracks in the following description can be physically in either arc segments or full circular or spiral tracks and logically arranged having track starting and ending points. FIG. 2 shows the format arrangement of a physical optical track segment or a logical data track wherein the physical optical track can be arc segments, concentric circular or spiral circular configuration, or. A logical data track with logical sectors is logical units addressed by operating system for data accesses. Logical data tracks are mapped to physical data tracks that can be part of a physical track or can occupy one or more physical tracks. Operating system requests data from a specified logical sectors and tracks, device converts the requested logical sectors and tracks to physical sectors and tracks locations to retrieve or update data. Starting from the beginning of a data track, a certain length or area is for an optical data access device to turn on focusing, tracking and lock on track functions. This starting sector is for an optical data access device to verify the track, sector addresses, and prepare for actual data access at the data sectors following starting sector. This starting sector is also for an optical pickup head to turn on the writing power in writing that is usually higher the reading power. The number of data sectors in a track depends on the physical construction of an optical track; an exit area follows data sectors before the end of logical optical track. The exit area can be small in length comparing to a data sector. The exit area is for seeking to next track servo adjustment and is for the optical pickup head to turn off focusing and tracking functions at a controlled manner. A pickup head for reading/writing data from the data tacks is therefore provided with information to timely turn on and turn off at the beginning and end of each data track and to operate with proper control parameters based on the information provided on the beginning and end sectors of each data track. In the subsequent description, data tracks can be either logical or physical tracks and interchangeable in discussions.

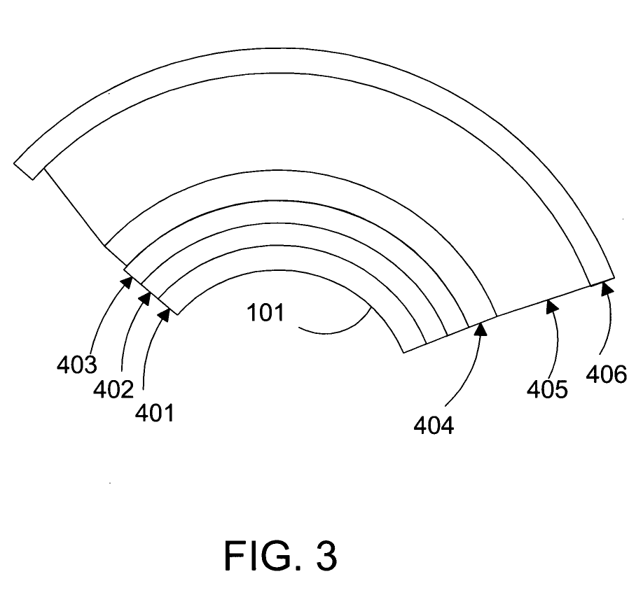

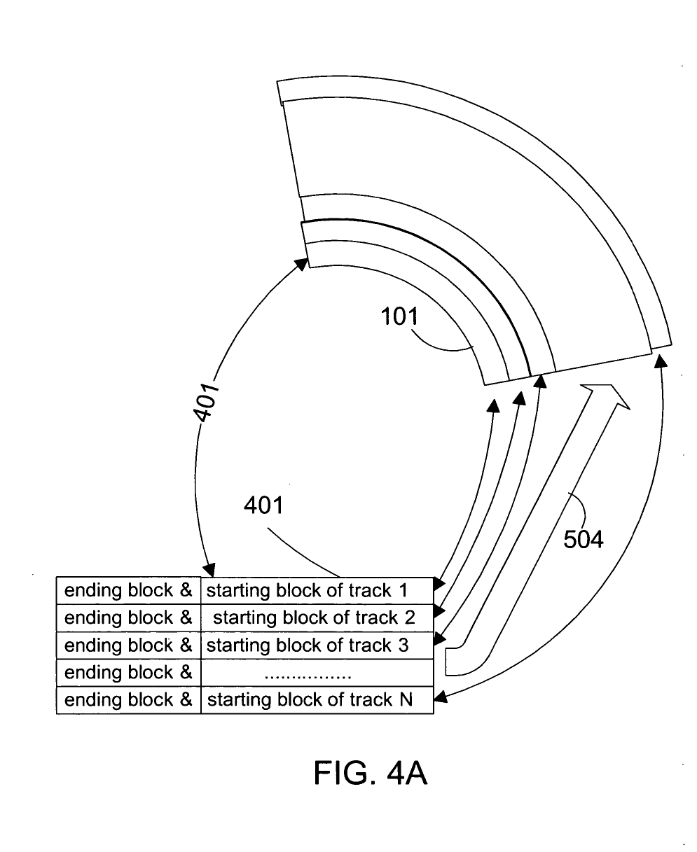

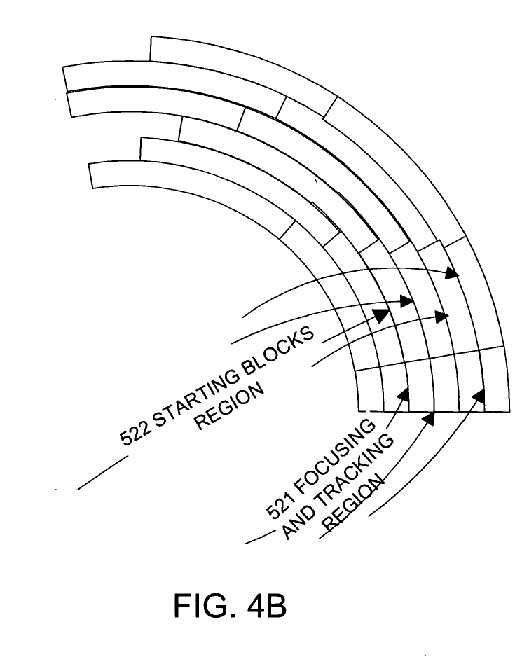

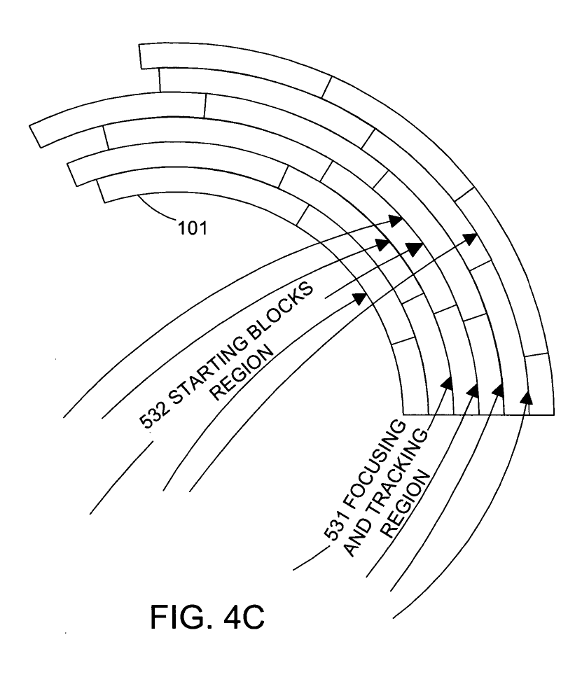

Referring to FIG. 3 for data provided to manage multiple sessions and to handle data track defects, the starting address sector as shown in FIG. 2 further includes a data for indicating a starting address per track table 401 a session management table 402, a defect management table 403. Separate areas, e.g., areas 404 and 405 are particularly reserved for data storage of different sessions and area 406 is reserved for defect sector alternative replacement process. Referring to FIG. 4A for more details of the starting address per track table 401 that is a table for a series of pointers 504. Each pointer stores the physical address of the starting and ending sectors of each track. FIG. 4B shows the focusing and tracking initial sector 521 and the starting block region 522 wherein these sectors are aligned across different data tracks along a same radial line. Alternately, FIG. 4C shows that the starting points of first sector 532 across tracks in 101 are not aligned along a radial line. The aligned or non-aligned configuration depends on the optical memory manufacturing process.

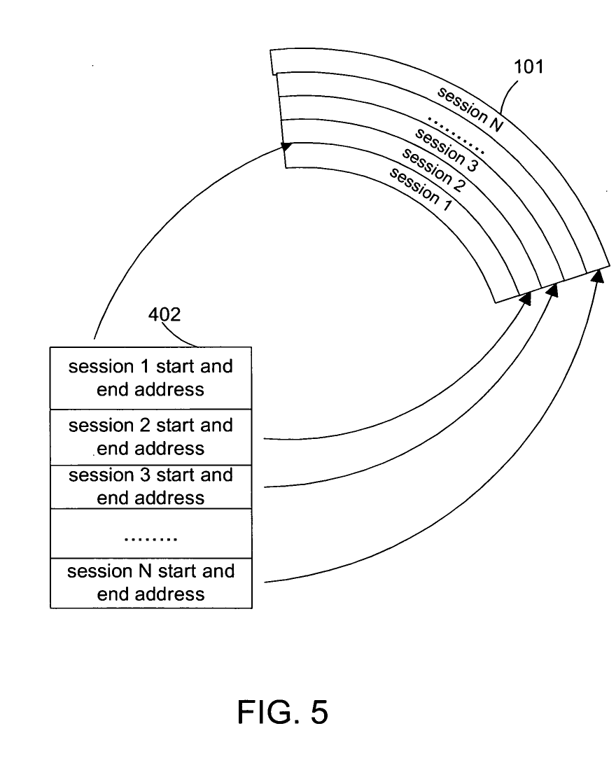

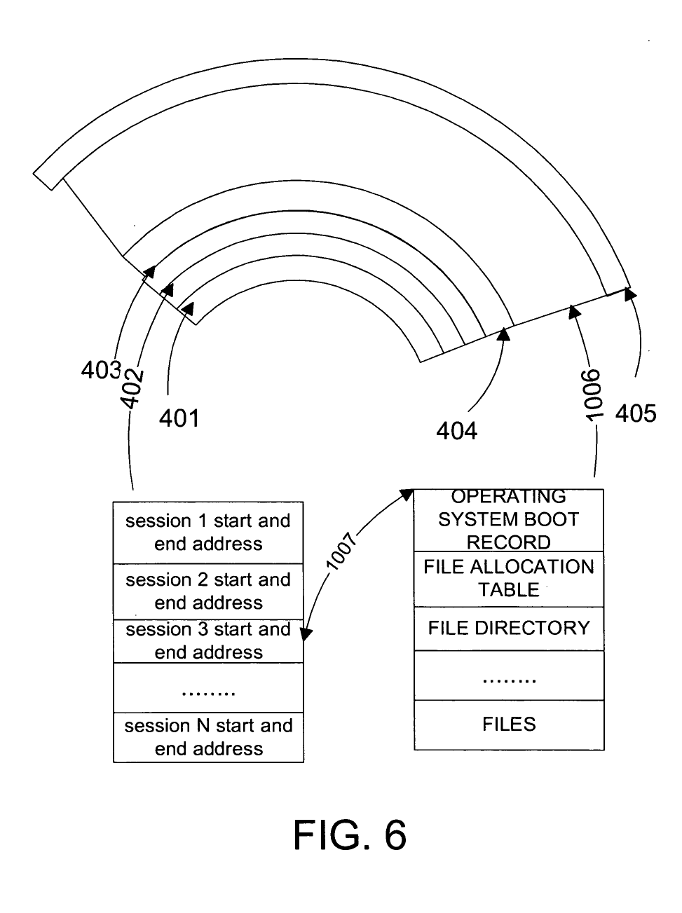

In order to perform multiple data access sections, the data track further provide data storage for storing data for different sessions. FIG. 5 shows each entry points to an area of tracks in 101 the starting address and ending address of a session if the session has been defined, otherwise, the entry or sector has no data. Specifically, as shown in FIG. 5, Table 402 is a session management table that has a sequence of entries. Each entry occupies a sector or track since the media is non-rewritable. In this invention, data in each session is set as a self contained direct access device with complete operating system boot record, file allocation table, file directory entries and file data as shown in FIG. 6 where a session pointer in table 402 points an area 1006 by a pointer 1007. Area 1006 has complete information and structure of a direct access device. With the boot record file provided, each session can be conveniently initiated and operated as an independent session. The last entry is usually the latest up to date data since the sessions are created in sequence by updating process. All previous sessions become invalid and provide still a backup and restore of old data only. A rewritable data card may needs only one session instead of multiple sessions for a non-rewritable data card.

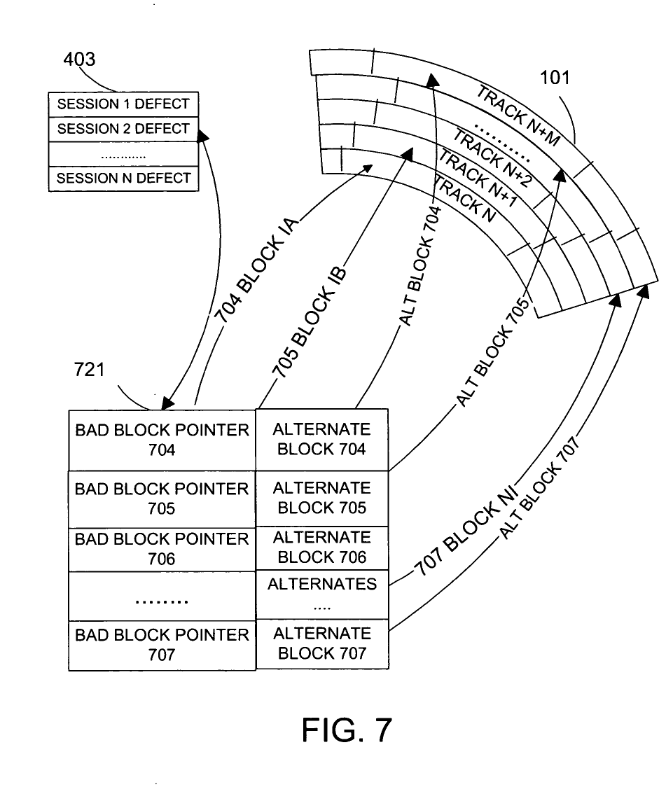

For the purpose of managing defective data track or defective areas as a portion of a data track, special sectors with defective management data are provided. FIG. 7 shows a table 403 with a series of defect sessions. Each entry 721 in table 403 has bad sector location addresses such as 704, 705, etc. and their alternative or replacement assigned location in the data storage area 102.

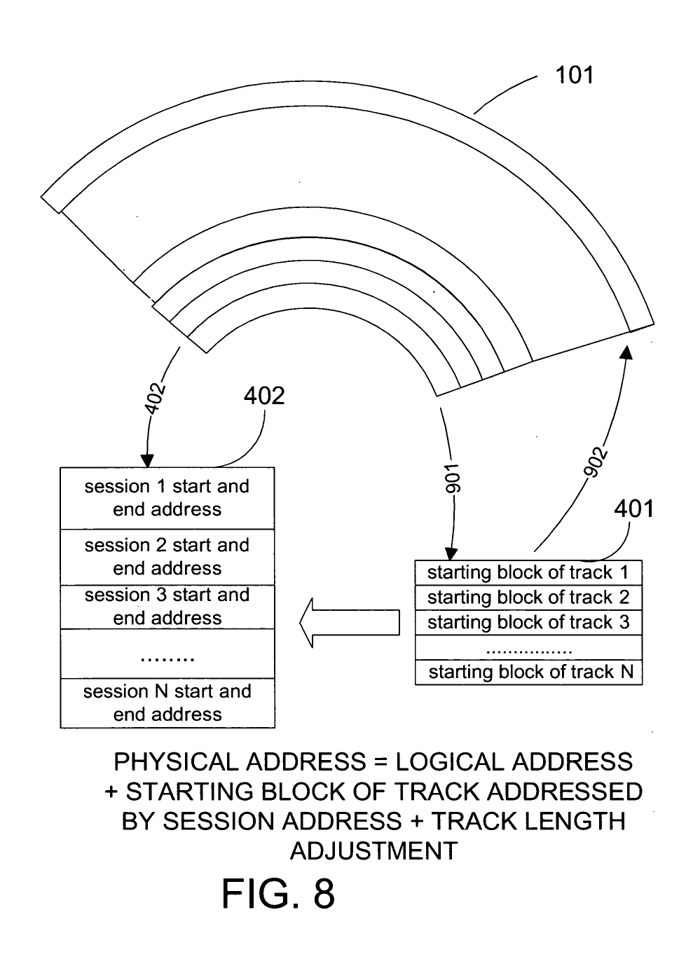

As the physical length of each sector in optical memory process is usually constant, the number of sectors per each track in 101 varies from less number of sectors at an inner region to more number of sectors toward the outer region at a circular area. Under this constraint, the manufacturing process can usually align only one sector across the tracks on a radial line, or just randomly spread from track to track. Since the number of sectors per each track varies, the starting sector address 522 or 532 of each track depends on manufacturing process. The starting sector number 522 or 532 can be pre-set equal to a multiple of number of sectors of the longest track, or equal to a multiple of a number that is larger than the number of sectors of the longest track, or just spread them from track to track according to its physical length geometry. Table 401 records starting sector number 522 or 532 of each track for an optical data access device to use in address mapping purpose explained in FIG. 8. Using the data provided by a table 402, FIG. 8 shows table 402 contains a series of session address pointers and table 401 has the starting address of each physical track 522 or 532. The issues related to different number of sectors in each data track are therefore resolved.

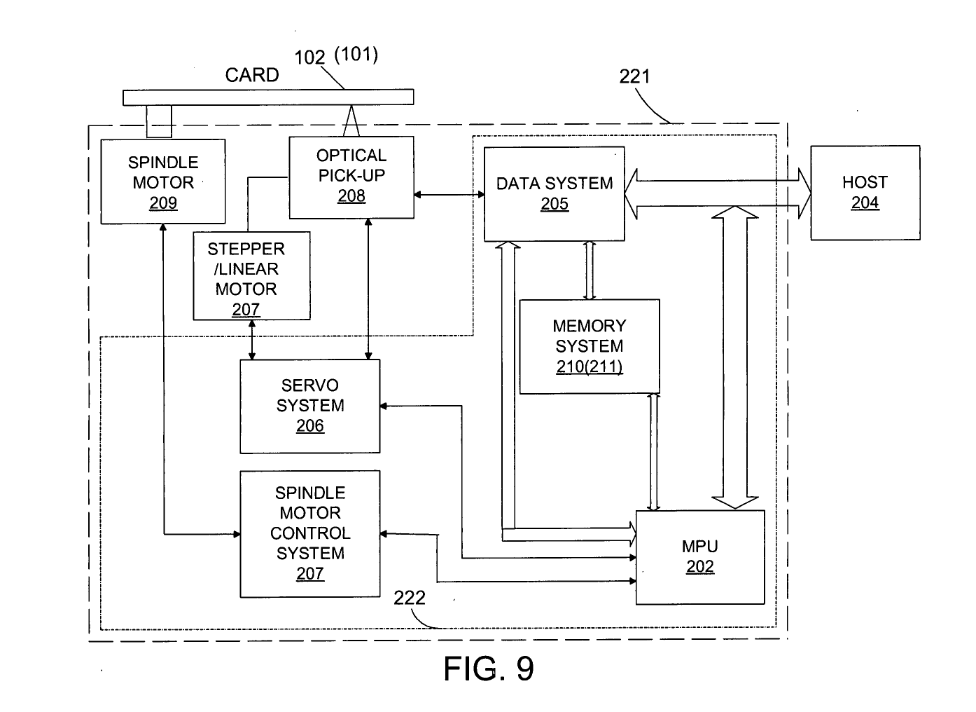

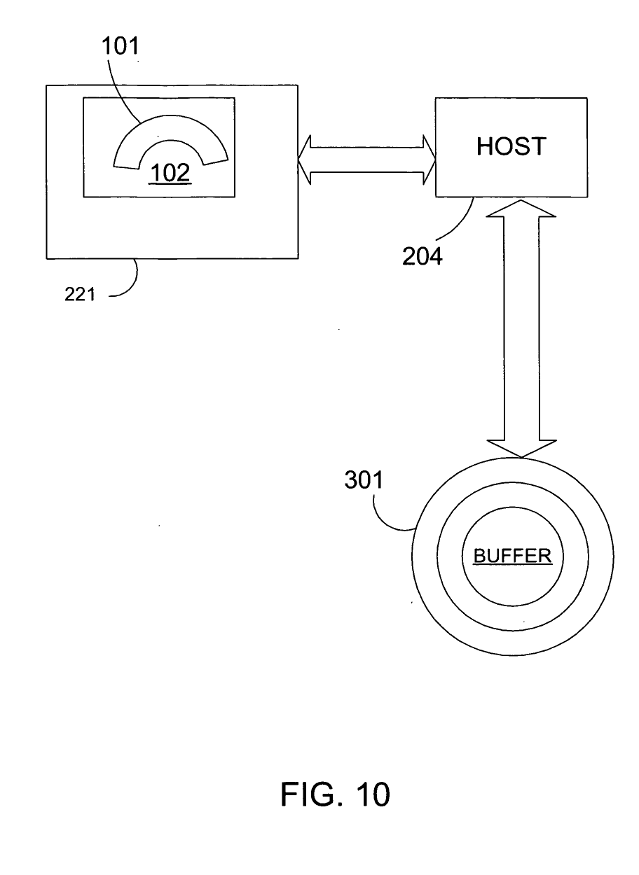

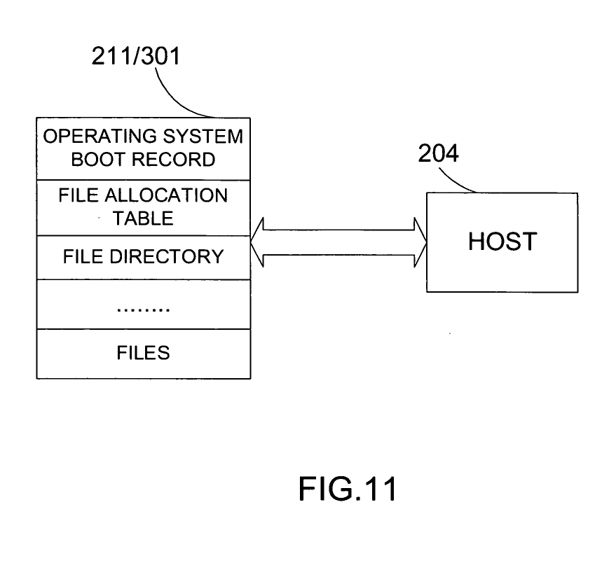

For the purpose of reading/writing data to the optical data tracks 101 supported on the data storage card 102, an optical data access device 221 interfacing with a host computer 204 is shown in FIG. 9. FIG. 9 shows a functional block diagram of the optical device 221 for carrying out data access operations to the data card 102 through an optical pickup head 208 driving by a spindle motor 209 and a stepper linear motor 207 controlled by a servo system 206 and a spindle motor control system 207. The servo system 206 and the spindle motor control system 207 are part of a device controller 222 that further includes a microprocessor unit (MPU) as an intelligent processor to issue control command by receiving signals from the servo system 206 and the spindle motor control 207 and further by communicating with a memory system 210 and a data system 205 where data system 205 receives data and feedback signals directly from the pickup head 208. The MPU 202 further communicates with a host computer 204 connected with data buses such as IDE parallel, IDE serial, SCSI, USB, etc between the MPU 211 and the host 204 and between the data system 205 and the host. Multiple sessions of data updates and corrections and defective data track managements are then processed through the cooperation between the MPU 202 and the host computer 204. The MPU 202 also uses functions of data system 205 to encode and decode data accessed at data card 102 for retrieval or storage under the command of host 204. The Memory system 210 provides temporary data storage and retrieval in controller functions for 205, 206, and 207. The memory system 210 further temporarily stores the instruction sequences of MPU 202 and provides the function as data buffers for various MPU and data access functions controlled by MPU 202. For the purpose of achieving multiple sessions of data updates, the memory system further serve the function as an emulated disc buffer 211. The details of the emulated buffers will be further described below in FIGS. 10 and 11. The emulated disc buffer 211 is under the control of MPU 202 to interface with the host 204.

FIG. 10 shows an equivalent buffer 311 of the buffer 211 in the memory system 210. This equivalent buffer 311 is an emulated disc buffer 301 and is under the control of the host 204. Instead of the MPU controlling the buffer 211 as the configuration shown in FIG. 2, the host 204 sets up the operation system boot record, the file allocation table, the file directory, and the files directly. In retrieving data, the host 204 updates data directly to buffer 301. In updating data, host 204 gets data from device 221 and transfers to buffer 301, updates the data to buffer 301 as needed. Once the updating of buffer 301 is complete, host 204 sends data from buffer 301 back to device 221. Device 221 writes data back to 101. The MPU 202 manages the buffer 211 in FIG. 9 and the host 204 manages buffer 301 in FIG. 10. They are mutually independent when undergoing the processes of maintaining and updating the data contents of in these two different buffers but operate in sequential order in a coordinated manner to allow the optical data card 101 to have multiple sessions of data updates and data error corrections.

A card-shaped information-recording medium is therefore disclosed in this invention. The card-shaped information-recording medium comprises a plurality of data tracks disposed in a data access area comprising data to enable a data handling system to process the card-shaped information-recording medium as a logic device. In a preferred embodiment, the plurality of data tracks further comprises data to enable a data handling system to process the non-rewritable card-shaped information-recording medium as a hard disk. In another preferred embodiment, the plurality of data tracks further comprising an operating system boot record, a file allocation table, a file directory and data file to enable a data handling system to process the card-shaped information-recording medium as a hard disk. In another preferred embodiment, the card-shaped information-recording medium further includes a first segment in the data tracks storing an address pointing to a multiple session management location in the data tracks employed for carrying out multiple sessions of data updates on the non-rewritable card-shaped recording medium. In another preferred embodiment, the card-shaped information-recording medium further includes a second segment in the data tracks for storing an address pointing to a defect management location in the data tracks for storing data employed for managing a defect in the data tracks. In another preferred embodiment, the plurality of data tracks comprises a plurality of data arc segments. In another preferred embodiment, the plurality of data tracks comprises a continuous data track having a beginning point and an end point, e.g., a circular track or a spiral track. In a preferred embodiment, the card-shaped information-recording medium is a non-rewritable card-shaped information-recording medium. In another preferred embodiment, the card-shaped information-recording medium is a rewritable card-shaped information-recording medium.

According to above description, a data access device for accessing data stored card-shaped information-recording medium is disclosed. It includes a plurality of data tracks disposed on the card-shaped information-recording medium including a first segment in the data tracks storing an address pointing to a multiple session management location in the data tracks employed for carrying out multiple sessions of data updates on the card-shaped recording medium. In a preferred embodiment, the data access device further includes a second segment in the data tracks for storing an address pointing to a defect management location in the data tracks for storing data employed for managing a defect in the data tracks. In another preferred embodiment, the data access device further includes a beginning sector in each of the data tracks for storing data for the data access device to perform a focusing and tracking on the data tracks. In another preferred embodiment, the data access device further includes an ending sector in each of the data tracks for storing data for a data access device to exit from each of the data tracks and to end a data access operation. In another preferred embodiment, the data access device further includes a starting sector following a focusing and tracking sector disposed at a beginning of each of the data tracks sector, and the starting sector storing data for indicating number of sectors and an address of each of the sectors in each of the data tracks. In another preferred embodiment, the data access device further includes a focusing and tracking sector disposed at a beginning of each of the data tracks with each focusing and tracking sector in each of the data tracks aligned with each other. In another preferred embodiment, the data access device further includes a focusing and tracking sector disposed at a beginning of each of the data tracks with each focusing and tracking sector in each of the data tracks misaligned with each other. In another preferred embodiment, the data access device further includes a session management data including an operating system boot record, a file allocation table, a file directory and data file stored in the data tracks pointed by the address in the multiple session management location. In another preferred embodiment, the data access device further includes a bad block pointer and alternate block data stored in the defect management location. In another preferred embodiment, the data access device further includes a bad block pointer and alternate block data stored in the defect management location and a replacement data stored in the data tracks pointed by the alternate block data. In another preferred embodiment, the data access device further includes an emulated buffer in the data access device comprising an operating system boot record, a file allocation table, a file directory and data file for preparing to perform multiple session data updates in the card-shaped information-recording medium. In another preferred embodiment, the data access device further includes a host computer connected to the data access device and the data access device and the host computer each comprising an duplicated copy of an emulated buffer comprising an operating system boot record, a file allocation table, a file directory and data file for preparing to perform multiple session data updates in the card-shaped information-recording medium. In another preferred embodiment, the data access device further includes a first and a second duplicated copy of an emulated buffer comprising wherein the emulated buffer an operating system boot record, a file allocation table, a file directory and data file whereby the data access device is provided to process in the card-shaped information-recording medium as a logic device and ready to perform multiple-session data updates in the non-rewritable card-shaped information-recording medium. In a preferred embodiment, the card-shaped information-recording medium is a non-rewritable card-shaped information-recording medium. In another preferred embodiment, the card-shaped information-recording medium is a rewritable card-shaped information-recording medium

For practical application, a computer system can set up a reading device 221 to access card medium 102 to retrieve data from 101 in a point of sale environment. To write or update data to optical data storage area 101, the processes described above in FIGS. 9 and 10 of this invention provide a system arrangement with a host 204 accessing data from card media 102 with an optical non-rewritable data storage area 101. Host 204 also interfaces with an emulated disc memory 301 or 211 that stores the retrieved data from 101. The Host 204 updates data as required. After finishing all updates, host 204 writes the updated data at 211 or 301 back to 101. The host 204 can create data without any merging of data from 101. In actual operations, the host 204 creates all the data at 211 or 301 first. After verifying and correcting data as necessary, host 204 transfers data from 211 or 301 to 101. The configuration of an emulated disc 211 or 301 is set to duplicate in size and configuration of a session at 101 with operating system boot record, file allocation table, file directory, and files as shown in FIG. 11. As that shown in FIG. 11, the host 204 treats 211 or 311 as a direct access memory device that can be accessed as a logical device such as a hard disk drive in a computer system setup. Another preferred system configuration of this invention is to implement the functions perform by the host 204 in the MPU 202 by providing and invoking another MPU program to perform the functions with another duplicated emulated buffer set up in the memory 210 such that the data access device 221 can function as a stand alone unit to manage the data interface to the outside world of device 221 and the emulation of device disc buffer 211. The data access device is enabled to carry out the multiple sessions of data updates or error corrections without relying on the availability of a host when the data access device is certified and qualified with sufficient security clearance levels or system management privileges.

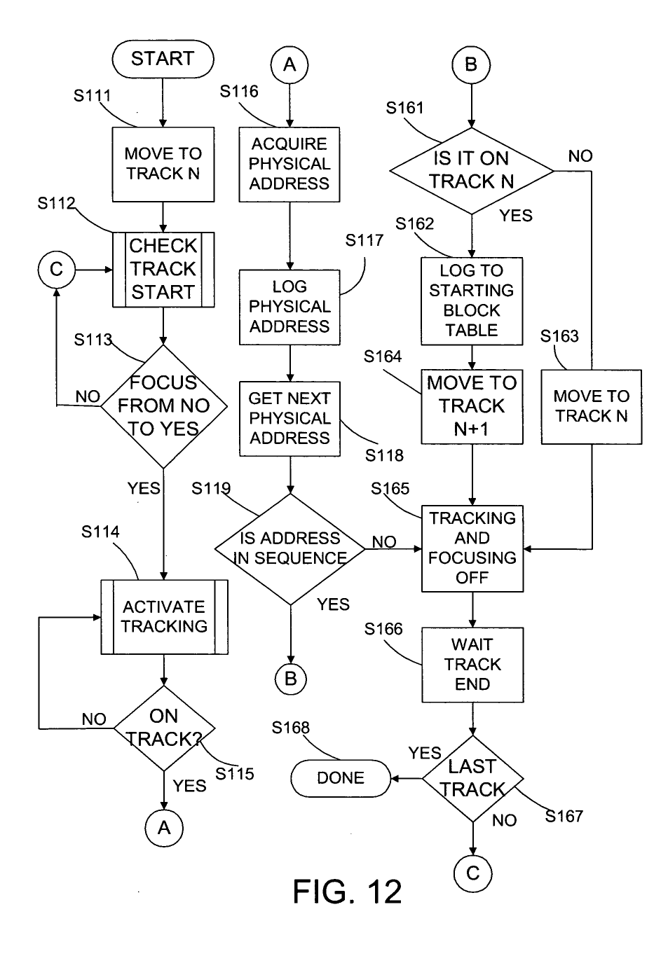

FIG. 12 shows the method to generate the starting and ending block table 401 as that shown in FIG. 4A. Starting from the innermost track, the device 221 moves to the selected track N (step S111) starts to detect the addresses of the starting sector 522 and 532 (Step S112) by using the focus information. A determination is made based on the focus detection (step S113), if the focus is found that changes from NO focusing signal to YES, the focus signal is a valid signal, then the process continue to activate a tracking process (step S114), otherwise, the process loops back to step S112. The step S114 activates the tracking servo to enable the optical pick-up unit 208 to follow the selected track. Then a determination is made (step S115) to check if the tracking is locked. An “on track” condition indicates the system can proceed to S116; otherwise system loops between S114 and S115 until the lock on track is valid. In step S116 a physical address of a sector is acquired by decoding the signal followed by logging the decoded address (Step S117). The in step S118, the physical address of next sector is calculated that allows a next step S119 to compare two addresses decoded at S117 and S118. When two addresses are in sequence, they are on the same track. If the determination made in step S119 finds that the addresses are not valid then a jump is made to step S165 to carry out a retry process S165. If the comparison made in step S119 finds out that the addresses are in sequence, then another determination is carried out in step S161 to verify the addresses are valid and in track N before the process proceed to step S162 to log the starting block table with the starting sector address written to a buffer. The process proceeds by moving the pickup head to next track N+1 (step S164). If it is determined in step S161 that the track is not really the target track, a step S163 is taken to perform a re-seek to the selected track referring to the decoded track address. At the end of the track, the tracking and focusing functions are turned of (step S165) and finishing the data collections and ready for next step (step S166). If all the tracks have been processed (Step S167), the process proceeds to step S168 to transfer the buffer data collected at S162 to table 401 at card memory 101 or back to S112 to start another process. Once the starting sector of a track is determined, device controller 222 can keep the OPU 208 on track between process S162 and S165 until reaches the end of track and lost the focusing and tracking to decode the ending sector address, the last valid address on this track is the end of the track address to fill the table 401 in FIG. 4A.

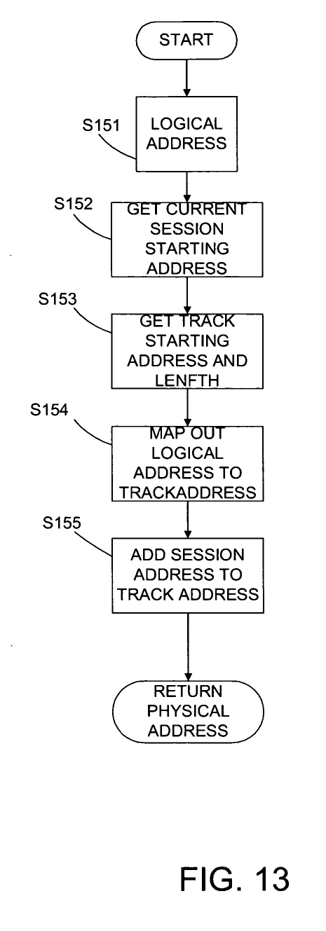

Referring to FIG. 13 for the process that the optical device 221 converts a logical data block address requested by a host 204 to an actual physical address in the optical card 101. Once the optical device 222 receives a logical address request at step S151 either from the host 204 or from the internal generated request through the MPU 202, the optical device uses table 402 to identify the current session and the session start address (step S152) then proceeds with a step S153 to apply table 401 to acquire the starting address of each track used in the session. The logic address to the data sector is mapped out one by one by starting from the first track of this session until the requested track address is reached (step S154), The matched physical address is determined by adding the session address o the track address (step S155) and the process is returned with a physical address.

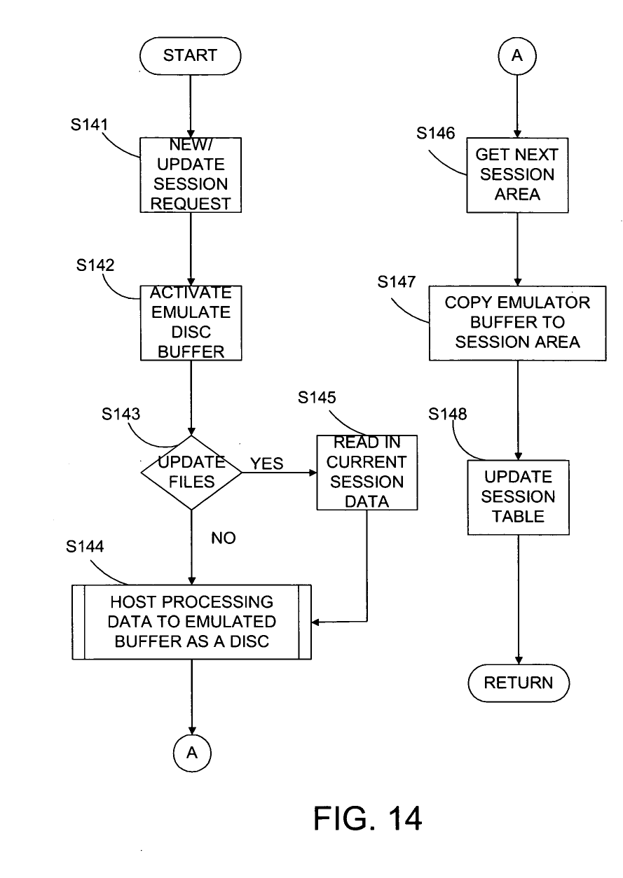

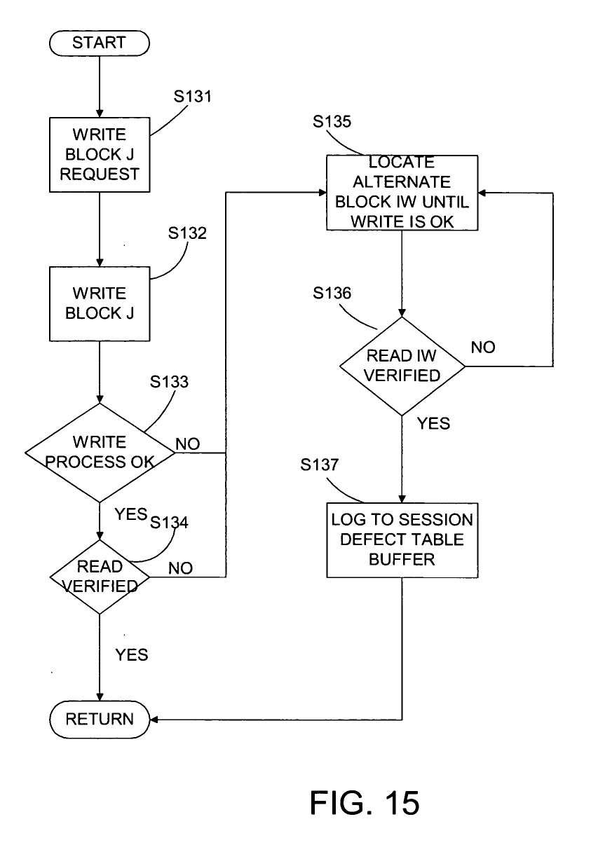

As described above, the emulated disc buffer 211 or 301 is a logical duplication of a session 1006 in configuration. The entries at table 402 are filled progressively as more sessions being created until the media is out of memory space. FIG. 14 shows a method of using table 401 to fill the entries in Table 402. As a session request reaches (step S141), device 221 or host 204 activates an emulated disk buffer 211 or 301 (step S142). A determination is made to determine Process the request is to update an existing session with files of to create a session with new data (step S143). If the updating of a session is required, then the data for the current session is inputted for carrying out a data update (step S145). Before any data is transferred back to device 221, host 204 uses data buffer 211 or 301 to manipulate data, read or write like a direct device. Once all the data manipulations, readings and writings are completed (step S144), host 204 and device 221 locate the next available session area from table 402 by searching table 402 to determine the last entry with valid data that are the starting and ending address of last session (step S146). There should not be any session entry after this last entry. The next available session area pointer in table 402 is calculated from the ending address of the last session plus a predetermined offset, for example, two. With session address determined, all data in the emulated disc buffer 211 or 301 beginning with operating system boot record, file allocation table, file entry directory, and all file data are copied to the newly created session (step S147). The size or the area of this session occupies and updates table 402 with starting address and ending address are recorded (step S148). In copying data to a session area, device 221 also generates a defect table as needed at table 403. Each session has a separate defect table in table 403.

Referring to FIG. 15 for a method to generate table 721. As S131 a write block request is received (step S131), the write request is processed and a write request is carried out (step S132) then a check is made to determine if the write process is completed successfully (step S133) followed by a read verification (step S134) if the write process is checked out satisfactory. On the other hand, if it is detected that the write process fails, an alternate block is located (step S135). Similarly, if the read verification cannot verify the written data with read verify, again, an alternate block is located (step S135), otherwise, a successful read verification completes the process. In alternative process, an available sector IW in area 406 is located and tests are performed for the data written to IW and a read verification is performed (step S136). If the tests failed, then the system repeats steps S135 and S136 processes until they are successful. The bad sector address and replacement address at a buffer are recorded for later copying to table 721 (step S137). The operation of Table 721 writing to table 402 is done at the end of completion of a session.

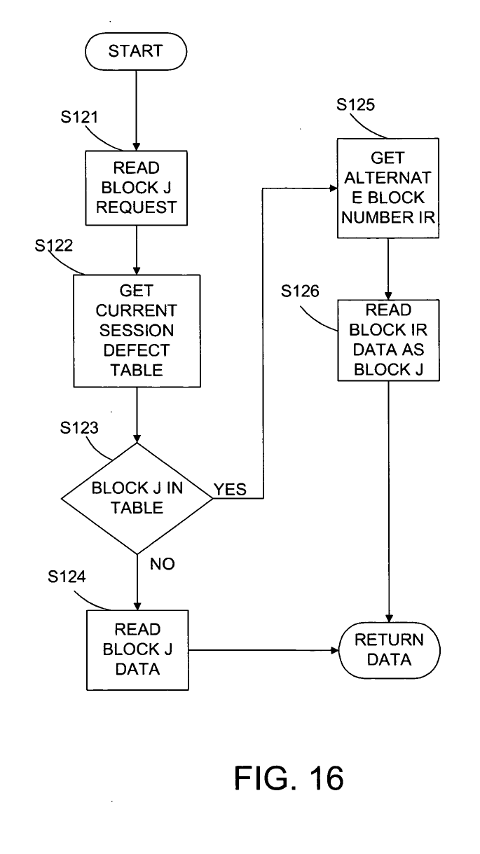

FIG. 16 shows the process to enter data into the defect Table 721 and how this table is used during a read request. The process begins with the receipt of a read request (step S121) for data at address J. The current defect table 721 is retrieved and made available from the defect session table 403 (step S122). A check is made to determine if the request block address J exists in Table 721 (step S123), if it is not, the process proceeds with a read operation from the block J (step S124) and the process is completed. If table 721 shows that the request block address J is a defect, then an alternate location IR is located (step S125) and the data in block IR is read instead of the block J, and the process is returned with the data at IR as the data read from the address at the J block.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1. A method for enabling multiple sessions of data updates in a card-shaped information-recording medium comprising:
providing a plurality of data tracks on said card-shaped information-recording medium and allocating a segment of said data tracks for providing an address pointing to a multiple session management location in said data tracks employed for carrying out said multiple sessions of data updates.

2. The method of claim 1 further comprising a step of:
allocating a segment of said data tracks for providing an address pointing to a defect management location in said data tracks for storing data employed for managing a defect in said data tracks.

3. The method of claim 1 further comprising a step of:
allocating a beginning sector or area in each of said data tracks for storing data for a data access device to perform a focusing and tracking on said data tracks.

4. The method of claim 1 further comprising a step of:
allocating an ending sector or area in each of said data tracks for storing data for a data access device to exit from each of said data tracks and to end a data access operation.

5. The method of claim 1 further comprising a step of:
allocating a sector as a starting sector wherein said starting sector following a focusing and tracking sector disposed at a beginning of each of said data tracks sector, and said starting sector storing data for indicating number of sectors and an address of each of said sectors in each of said data tracks.

6. The method of claim 1 further comprising a step of:
allocating a beginning sector in each of said data tracks with each beginning sector in each of said data tracks aligned with each other for storing data for a data access device to perform a focusing and tracking on said data tracks.

7. The method of claim 1 further comprising a step of:
allocating a beginning sector in each of said data tracks with each beginning sector in each of said data tracks misaligned with each other for storing data for a data access device to perform a focusing and tracking on said data tracks.

8. The method of claim 1 further comprising:
storing a session management data including an operating system boot record, a file allocation table, a file directory and data file in said data tracks pointed by said address in said multiple session management location.

9. The method of claim 2 further comprising:
storing a bad block pointer and alternate block data in said defect management location.

10. The method of claim 2 further comprising:
storing a bad block pointer and alternate block data in said defect management location and storing a re placement data in said data tracks pointed by said alternate block data.

11. The method of claim 1 further comprising:
generating an emulated buffer in a data access device comprising an operating system boot record, a file allocation table, a file directory and data file for preparing to perform a multiple session data update in said card-shaped information-recording medium.

12. The method of claim 1 further comprising:
connecting a host computer to a data access device and generating an emulated buffer in a data access device and in said host computer wherein said emulated buffer comprising an operating system boot record, a file allocation table, a file directory and data file for preparing to perform a multiple session data update in said card-shaped information-recording medium.

13. The method of claim 1 wherein:
said step of providing a plurality of data tracks on said-card-shaped information-recording medium further comprises a step of providing said plurality of data tracks on a card-shaped non-rewritable information-recording medium.

14. The method of claim 1 wherein:
said step of providing a plurality of data tracks on said-card-shaped information-recording medium further comprises a step of providing said plurality of data tracks on a card-shaped rewritable information-recording medium.

15. The method of claim 14 further comprising:
storing data including an operating system boot record, a file allocation table, a file directory, and data file, in a data access device for preparing to perform a multiple session data update in said rewritable card-shaped information-recording medium.

16. The method of claim 14 further comprising:
connecting a host computer to a data access device and storing data including an operating system boot record, a file allocation table, a file directory, and data file, in said computer and data access device for preparing to perform a multiple session data update in said rewritable card-shaped information-recording medium.

17. A data access device for accessing data stored in card-shaped information-recording medium comprising:
a plurality of data tracks disposed on said card-shaped information-recording medium including a first segment in said data tracks storing an address pointing to a multiple session management location in said data tracks employed for carrying out multiple sessions of data updates on said card-shaped recording medium.

18. The data access device of claim 17 further comprising:
a second segment in said data tracks for storing an address pointing to a defect management location in said data tracks for storing data employed for managing a defect in said data tracks.

19. The data access device of claim 17 further comprising:
a beginning sector in each of said data tracks for storing data for said data access device to perform a focusing and tracking on said data tracks.

20. The data access device of claim 17 further comprising:
an ending sector in each of said data tracks for storing data for a data access device to exit from each of said data tracks and to end a data access operation.

21. The data access device of claim 17 further comprising:
a starting sector following a focusing and tracking sector disposed at a beginning of each of said data tracks sector, and said starting sector storing data for indicating number of sectors and an address of each of said sectors in each of said data tracks.

22. The data access device of claim 17 further comprising:
a focusing and tracking sector disposed at a beginning of each of said data tracks with each focusing and tracking sector in each of said data tracks aligned with each other.

23. The data access device of claim 17 further comprising:
a focusing and tracking sector disposed at a beginning of each of said data tracks with each focusing and tracking sector in each of said data tracks misaligned with each other.

24. The data access device of claim 13 further comprising:
a session management data including an operating system boot record, a file allocation table, a file directory and data file stored in said data tracks pointed by said address in said multiple session management location.

25. The data access device of claim 18 further comprising:
a bad block pointer and alternate block data stored in said defect management location.

26. The data access device of claim 18 further comprising:
a bad block pointer and alternate block data stored in said defect management location and a replacement data stored in said data tracks pointed by said alternate block data.

27. The data access device of claim 17 further comprising:
an emulated buffer in said data access device comprising an operating system boot record, a file allocation table, a file directory and data file for preparing to perform multiple session data updates in said card-shaped information-recording medium.

28. The data access device of claim 17 further comprising:
a host computer connected to said data access device and said data access device and said host computer each comprising an duplicated copy of an emulated buffer comprising an operating system boot record, a file allocation table, a file directory and data file for preparing to perform multiple session data updates in said card-shaped information-recording medium.

29. The data access device of claim 17 further comprising:
a first and a second duplicated copy of an emulated buffer comprising wherein said emulated buffer an operating system boot record, a file allocation table, a file directory and data file whereby said data access device is provided to process in said non-rewritable card-shaped information-recording medium as a logic device and ready to perform multiple-session data updates in said card-shaped information-recording medium.

30. The data access device of claim 17 wherein comprising:
said plurality of data tracks are disposed on a non-rewritable card-shaped information-recording medium.

31. The data access device of claim 17 wherein comprising:
said plurality of data tracks are disposed on a rewritable card-shaped information-recording medium.

32. The data access device of claim 30 further comprising:
a host computer connected to said data access device and said data access device and said host computer each comprising an duplicated copy of an emulated buffer comprising an operating system boot record, a file allocation table, a file directory and data file for preparing to perform multiple session data updates in said non-rewritable card-shaped information-recording medium.

33. The data access device of claim 31 further comprising:
a host computer connected to said data access device and said data access device and said host computer each comprising an duplicated copy of an emulated buffer comprising an operating system boot record, a file allocation table, a file directory and data file for preparing to perform multiple session data updates in said rewritable card-shaped information-recording medium.

34. A card-shaped information-recording medium comprising:
a plurality of data tracks disposed in a data access area comprising data to enable a data handling system to process said card-shaped information-recording medium as a logic device.

35. The card-shaped information-recording medium of claim 26 wherein:
said plurality of data tracks further comprising data to enable a data handling system to process said non-rewritable card-shaped information-recording medium as a hard disk.

36. The card-shaped information-recording medium of claim 34 wherein:
said plurality of data tracks further comprising an operating system boot record, a file allocation table, a file directory and data file to enable a data handling system to process said card-shaped information-recording medium as a hard disk.

37. The card-shaped information-recording medium of claim 34 further comprising:
a first segment in said data tracks storing an address pointing to a multiple session management location in said data tracks employed for carrying out multiple sessions of data updates on said card-shaped recording medium.

38. The card-shaped information-recording medium of claim 34 further comprising:
a second segment in said data tracks for storing an address pointing to a defect management location in said data tracks for storing data employed for managing a defect in said data tracks.

39. The card-shaped information-recording medium of claim 34 wherein:
said plurality of data tracks comprising a plurality of data arc segments.

40. The card-shaped information-recording medium of claim 34 wherein:
said plurality of data tracks comprising a continuous data track having a beginning point and an end point.

41. The card-shaped information-recording medium of claim 34 is a non-rewritable card-shaped information-recording medium.

42. The card-shaped information-recording medium of claim 34 is a rewritable card-shaped information-recording medium.
